(19) United States
(12) Patent Application Publication
(10) Pub. No.: US 2007/0234316 A1
(43) Pub. Date: Oct. 4, 2007

(54) Methods and systems for development of software for complex systems

(75) Inventor: Bernd Heinrich Bayerlein, Heidelberg (DE)

Correspondence Address: KENYON & KENYON LLP, 1500 K STREET N.W., WASHINGTON, DC, 20005, US

(73) Assignee: SAP AG

(21) Appl. No.: 11/368,537

(22) Filed: Mar. 7, 2006

(51) Int. Cl. G06F 9/45

(52) U.S. Cl. 717/140

(57) ABSTRACT

The present invention provides systems and methods that allow developers to manage software designed to run on a variety of target platforms. Embodiments of the invention allow developers to specify logical descriptors for source code segments or groups of source code segments. Since these logical descriptors may specify the validity of each source code segment, the number of source code segments to be maintained may be minimized, giving more flexibility in modeling complex dependencies of target platforms. These descriptors may be used to manage source code segments, select source code segments compatible with a specific target platform, and automate various processes involved in developing, testing and delivering software for execution on target platforms. Embodiments of the invention may also allow developers to create software that operates differently or provides different functionality when executed on different target platforms.

### BACKGROUND

When creating and maintaining software designed to run on complex target platforms, developers often must maintain multiple versions of the software in order to allow for compatibility with a variety of target platforms. Each version of the software might be designed for or compatible with a specific target operating system, database, network system, or other specific software and/or version of the target platform. That is, every combination of operating system, database, web browser, and other components on the target system might require a separate version of some or all of the components of the software being developed. For example, a source code segment designed for one combination of an operating system, a database, and a web browser might not work properly if used on the same operating system and database, but with a different web browser.

To address these problems, developers often use version and code management systems that organize source code segments into version trees and lists. In order to manage different versions of the same program designed for different target systems, developers may maintain multiple trees or lists, with one tree or list representing the source code segments relevant for one target system. This can lead to duplicate effort, as there may be minimal differences between some possible target platforms. Similarly, some source code segments may be compatible with multiple target platforms, requiring developers to include copies of those segments in each development tree or list. Modifying such a segment can be time consuming, as any modifications must be made in each copy of the source code segment.

Developers may also address these problems by refusing to provide support for older versions of the target system, omitting features that are only available in new releases, or writing source code segments that are usable with many different versions of the system. For example, developers may write one source code segment that issues different function calls depending on the target system on which it is installed. However, such code-writing practices may not be supported by static syntax checking systems and must avoid direct target platform references. Source code segments written with such methods must be verified for correct syntax at runtime, which can increase required testing effort and often results in runtime errors.

The limitations inherent in many versioning systems may also result in complications when testing and delivering complex systems. In testing, a complete version of the system must be assembled and tested for each target platform. This can be a time-consuming process, as every version of the system is compiled by including source code segments that are compatible with the target platform. Each version is then tested individually. Individual version testing may also be time-consuming, as a developer must examine each source code segment, tree, or list to determine if it should be included in the version being tested.

Similar problems arise when assembling code for shipment to customers. Each customer may have a different target platform on which the system will be installed. To insure that each customer receives all the files necessary for an installation of the system, multiple version trees often are maintained simultaneously. For example, a set of trees may be maintained for each operating system type and version, database type and version, and web browser type and version. Each version tree then results in a file to be delivered to customers. This results in many files being shipped to each customer; customers are then faced with a multitude of installation options, many of which may not be applicable to or compatible with their platform. Maintaining multiple release trees may allow for better adaptation to various target systems, but at the cost of increasing complexity for developers maintaining the various trees and increasing the effort necessary to reassemble and combine the proper version trees for testing or delivery. Such processes are often performed manually, further compounding the problems of assembling code for delivery.

Accordingly, there is a need for systems and methods to allow simplified management of software having multiple versions for several different target platforms.

### BRIEF DESCRIPTION OF THE DRAWINGS

FIG. 1 shows various systems according to an embodiment of the present invention.

FIG. 2 shows a process for managing source code segments according to an embodiment of the present invention.

FIG. 3 shows an example screenshot of a graphical user interface to a test system according to an embodiment of the present invention.

FIG. 4 shows a process for testing software according to an embodiment of the present invention.

FIG. 5 shows an example screenshot of a graphical user interface to a packaging system according to an embodiment of the present invention.

FIG. 6 shows a process for packaging software according to an embodiment of the present invention.

FIG. 7 shows an example source code segment hierarchy and associated logical descriptors according to an embodiment of the present invention.

### DETAILED DESCRIPTION

The present invention provides systems and methods that allow developers to manage software designed to run on a variety of target platforms. Embodiments of the invention allow developers to specify logical descriptors for source code segments or groups of source code segments. These descriptors may then be used to manage source code segments, select source code segments compatible with a specific target platform, and automate various processes involved in testing and delivering software for execution on specific target platforms. Embodiments of the invention may also allow developers to create software that operates differently, provides different functionality, or has other differences when executed on different target platforms. Systems and methods according to the present invention may provide benefits in developing, testing, and delivering software.

Source code segments may include logical conditions that specify target platform attributes for which each source code segment is valid. For example, a segment may include logical descriptors specifying an operating system name, a database name, and a minimum database version. The logical descriptors may also specify information about the source code segment or the program for which it is designed, such as indicating a version or range of versions of the software for which the segment is designed. Since the validity of each source code segment can be specified by attaching logical descriptors, developers may not need to maintain multiple copies of the same source code segment. For example, a single copy of a source code segment may be kept in a code repository, instead of maintaining copies of the same source code segment in multiple version trees. A system according to the invention may examine these descriptors in order to determine if the source code segment is valid for a specified target platform. When developing new source code segments, developers may use the system to retrieve information regarding already-existing source code segments, instead of relying on multiple, complex version trees.

Similarly, testing systems may be more automated with the use of logical descriptors. When a developer wishes to run a test of a specific version of the software, the developer may not need to track multiple version trees to assemble the system for testing. Instead, a developer or an automated test suite may analyze the logical descriptors associated with source code segments to determine compatibility with a specified target platform. Since each source code segment may include logical descriptors indicating the target platforms for which it is valid, an analysis system may assemble a list of source code segments required to create a specific version of the software to be tested. This may allow for rapid testing of multiple versions of the software. It may further allow for testing of the software on multiple target platforms, with less interaction required from testers or developers. For example, when adding a new target platform to a test environment, the processes of defining the new platform and assembling valid source code segments for testing may be partly or completely automated.

Embodiments of the invention may also allow for simplified delivery to customers. If a customer's target installation platform is known, a version of the software or required patches may be assembled. In order to assemble a version or patch, a developer may examine logical descriptors to determine which source code segments should be included with the version or patch to be shipped to the customer. Similarly, this process may be automated such that a developer specifies a target platform and an analysis system selects appropriate source code segments to be assembled. A target platform may also be selected and analyzed automatically. A version or patch may then be compiled that includes only those source code segments that are required for each customer. “Compiling” may include assembling the source code segments into an executable program or otherwise preparing the source code segments for execution on a target platform. Such a system and process may result in smaller installation files or packages, and may simplify installation for the end user. Developers may also use the logical descriptors to create software that is compatible with multiple target platforms. Such software may include logic that results in different performance of the software based on the presence or absence of attributes specified by the logical descriptors. For example, a developer may include the logical descriptors as part of the software. When the software is executed on a target platform, it may examine the logical descriptors in order to determine what features are available on the executing target platform. Thus, the software behavior may be different on different target platforms.

In some embodiments of the invention, logical descriptors may be embedded within each source code segment, for example as declarative statements in a text file. Each source code segment may also be a data object, with logical descriptors associated with each source code segment data object. As used herein, a “source code segment” may therefore refer to a text file containing computer-executable code, a data object, or any other appropriate mechanism for storing and/or manipulating human-readable or human-manipulable code that can be compiled into executable software or machine-readable code. Systems according to the present invention may be used to store and retrieve information about source code segment and target platform compatibility, and automate processes that require such information. Logical descriptors may also be applied to version trees, nodes and sub-nodes within version trees, or groups of source code segments. Thus, when a logical descriptor is described herein as being associated with a source code segment, it may similarly be associated with one or more source code segments, or with a group of source code segments having a logical, functional, or organizational relationship.

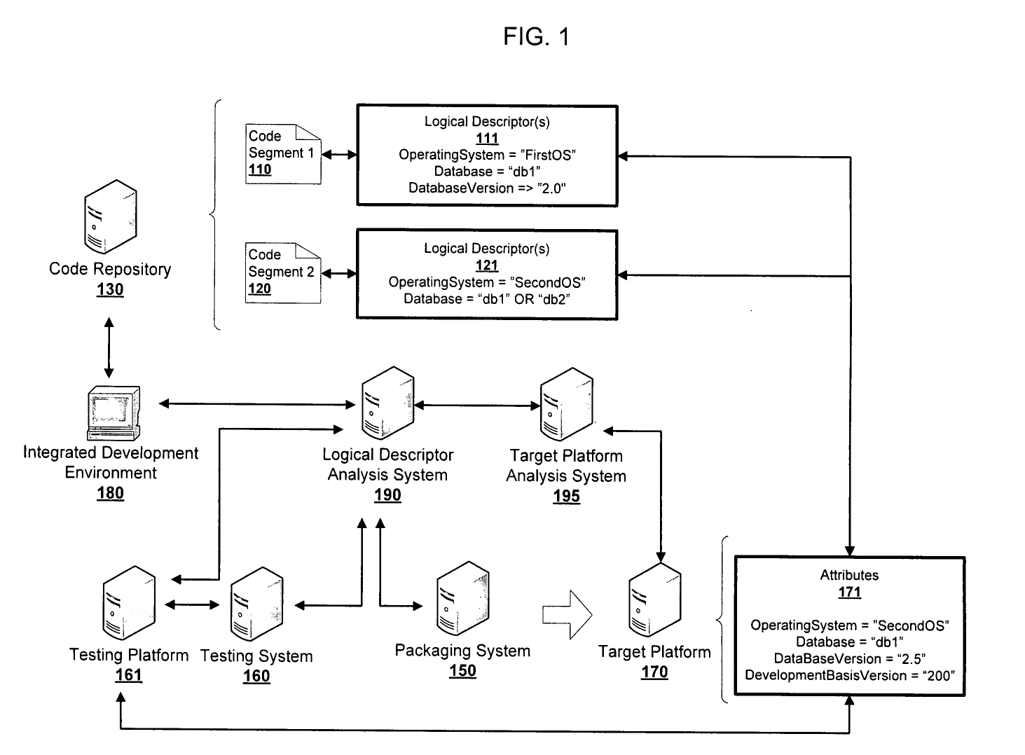

FIG. 1 shows various systems according to the invention. A code repository 130 may store various source code segments for use in one or more software programs. Each source code segment stored in the code repository, such as the source code segments 110 and 120 illustrated, may be associated with logical descriptors 111 and 121, respectively. The logical descriptors may specify operating systems, databases, version information, or other components or information about the target platform or platforms for which the source code segment is valid. For example, source code segment 110 has three logical descriptors 111 associated with it, which specify that the source code segment 110 is valid for a target platform running the “FirstOS” operating system, and having at least version 2 of the database “db1” installed. As illustrated in FIG. 1, logical descriptors according to the present invention may specify exact attributes of a target platform, such as a specific operating system, or they may specify various logical combinations of attributes, such as the minimum database version specified in the example. Other combinations of attributes are possible. For example, developers may create logical descriptors using logical operators and/or Boolean operators such as AND, OR, NOT, BETWEEN, and other operators. Logical statements may also be nested, such as by using parenthesis.

The logical descriptors 111, 121 associated with various source code segments 110, 120 may correspond to attributes 171 of a target platform 170. When software is developed for multiple target platforms, each target platform 170 may have a set of attributes 171 describing the types and versions of software present on the target platform. These attributes may be defined by developers, or they may be provided by a target platform, a program executed on the target platform, or a target platform analysis system 195. In FIG. 1, a target platform 170 has attributes 171 that describe the software present on the target platform. The attributes 171 indicate that the target platform 170 has the “SecondOS” operating system, version 2.5 of the database “db1”, and a development basis of version 200. In some embodiments, attributes may provide information about the software developed by a developer using the system. For example, the “DevelopmentBasisVersion” attribute 171 in FIG. 1 may represent a base version of the software being developed. The source code segments 110, 120 of concern to a developer may then be, for example, patches to a previously-installed version of the software. A set of attributes may describe each portion of a target platform, or they may only describe those portions that are relevant to a particular software program. For example, if a program does not require access to a database, attributes specifying a database type or version may be omitted from the description of target platforms for which the program is developed.

Developers may access source code segments and logical descriptors via an integrated development environment (IDE) 180. The IDE may provide information about logical descriptors automatically. For example, when a developer is editing a source code segment stored in the code repository, the IDE may provide a graphical interface displaying the attributes described by the logical descriptors. It may also provide a simplified way for a developer to add, delete, or modify the logical descriptors associated with a source code segment.

In some embodiments, a logical descriptor analysis system 190 may provide information about logical descriptors associated with source code segments. For example, it may analyze multiple source code segments stored in a code repository to provide aggregate information to an IDE 180. The analysis system 190 may also provide source code segments matching one or more selected logical descriptors or attributes. In some embodiments, a target platform analysis system 195 may analyze the software configuration of a target platform and provide information about the software configuration to the logical descriptor analysis system 190. For example, the target platform analysis system 195 may provide a list of attributes and/or logical descriptors that describe the operating system, installed databases, and other software present on a target platform 170. Alternatively, a developer may specify a target platform or attributes of a target platform such as via an IDE 180. The analysis system 190 may then examine source code segments 110, 120 to select those source code segments associated with logical descriptors 111, 121 matching the attributes specified by the developer or associated with the target platform specified by the developer. For example, in FIG. 1 a developer may specify a target platform having the attributes 171 shown. The analysis system 190 may then select each source code segment matching those attributes. In the example shown in FIG. 1, the analysis system 190 would select Source code segment 2 (120), since the logical descriptors 121 associated with the source code segment match the specified attributes 171. That is, Source code segment 2 is compatible with the operating system “SecondOS” and either database “db1” or “db2”. Since these conditions are met by the specified attributes 171, Source code segment 2 will be selected. Similarly, the analysis system will not select Source code segment 1 (110), since it requires the operating system “FirstOS” as specified by the logical descriptors 111 associated with the segment. Other analysis methods are possible. For example, a developer may require that source code segments selected by the analysis system 190 match all of the attributes of a target platform. Similarly, a developer may specify that source code segments should be selected that match some or any of the attributes.

Some embodiments of the invention may include a testing system 160. The testing system may allow for automation of testing various versions of a program, patch, or other software. A developer may specify one or many target platforms for testing. Source code segments having logical conditions that match attributes of each target platform may be selected. This selection may be done by the developer, by a logical descriptor analysis system 190 and/or a target platform analysis system 195 as previously described, or by the testing system 160. Source code segments determined to be compatible with the selected target platform may then be syntax checked by the testing system, or they may be assembled into a program that can be executed by the testing system 160. The testing system 160 may include one or multiple testing platforms 161, each testing platform having a software configuration representing a possible target platform. Such a platform may be a system having the same attributes as a selected target platform, to allow developers to test a program in conditions similar or identical to those under which the program is expected to be executed after delivery to a customer. For example, the testing platform 161 may have attributes 171 identical to the target platform 170. When a developer initiates a test of a program designed for the target platform 170, the testing system 160 may select source code segments compatible with the target platform. Similarly, the analysis system 190 may analyze source code segments to determine those segments compatible with the target system. The analysis system may then provide information about and/or the compatible source code segments to the testing system. Other information may be provided to the testing system, such as a list of source code segments that have logical descriptors matching only some of the attributes of the target platform.

Similarly, a packaging system 150 may be included in some embodiments of the invention. The packaging system may prepare one or more source code segments for delivery to a customer. When a program, patch, or other software is to be delivered to a customer, source code segments compatible with one individual target platform may be selected from a code repository. The source code segments may be selected by a developer, by a logical descriptor analysis system 190 and/or a target platform analysis system 195 as previously described, or by the packaging system 150. Once compatible segments have been selected, the packaging system may assemble the compatible segments into a program, patch, or other software for delivery. In some embodiments, the system may assemble a single program or patch that is compatible with multiple target platforms. In such embodiments, the packaging system 150 may include multiple source code segments having logical descriptors matching different target platform attributes. For example, the system may include segments designed for different databases. The logical descriptors associated with each source code segment may be included in the packaged software. When the software is run on a target platform, the software may examine the logical conditions to determine which source code segments should be executed. In some embodiments, the system may assemble multiple patches, each of which is compatible with a target platform or multiple target platforms. In such embodiments, a set of logical descriptors that describe valid target platforms for each patch may be associated with each patch or with the set of patches. For example, a patch may be created for each of two operating systems, “FirstOS” and “SecondOS,” but each patch may be compatible with any or all databases installed on a platform running the associated operating system. These logical descriptors may allow for automated assembly of the patches by a packaging system. As with a single patch, the logical descriptors associated with each patch may be included in the packaged software in order to provide different behavior after the software is installed on a target platform.

The examples and systems described with respect to FIG. 1 may have various network and hardware topologies and configurations. Systems and programs may be stored and/or executed on one or more servers, and various servers may be connected via a communications network. Source code segments, logical descriptors, and other information may be stored in any appropriate medium, such as an external database. The specific arrangement, topology, and configuration of servers, programs, and storage is irrelevant unless otherwise specified herein.

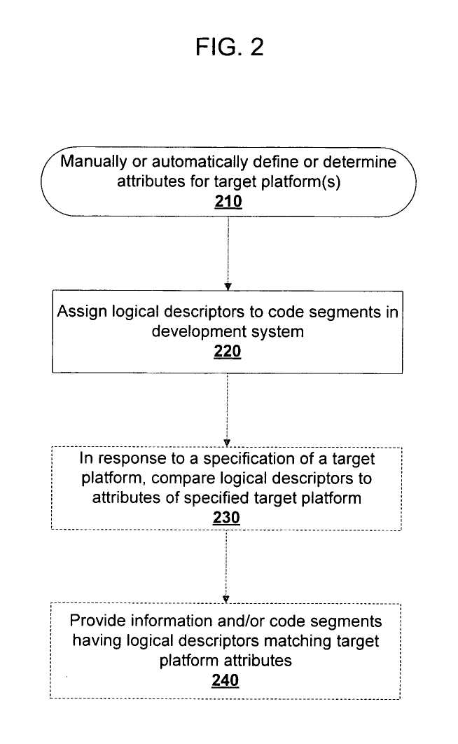

An example process for using logical descriptors according to the invention is shown in FIG. 2. Attributes for one or more target platforms may be created 210. These attributes may be defined by a developer, or they may be provided by a target platform or a program executed on the target platform. The attributes may also be determined by a target platform analysis system as described with respect to FIG. 1. For example, a program may be executed on a target platform that analyzes software installed on the platform and sends a list of software and version information to a developer. Other methods may be used to construct a set of attributes describing the target platform. Based on the attributes describing each possible target platform on which a software program is to be installed and executed, a developer may associate logical descriptors with one or more source code segments 220. The logical descriptors may specify operating systems, software, and version information for which the segment is valid. The descriptors may also use logical operators such as AND, OR, < (less than), > (greater than), and other operators as previously described. When a developer wants to modify or examine compatibility of source code segments, he may specify a target platform 230. The target platform may be indicated to an analysis system, an IDE, or other system as previously described with respect to FIG. 1. One or more systems may then analyze logical descriptors associated with source code segments, and provide compatibility information and/or compatible source code segments 240. This information may be provided directly to the developer, or it may be displayed in a program such as an IDE.

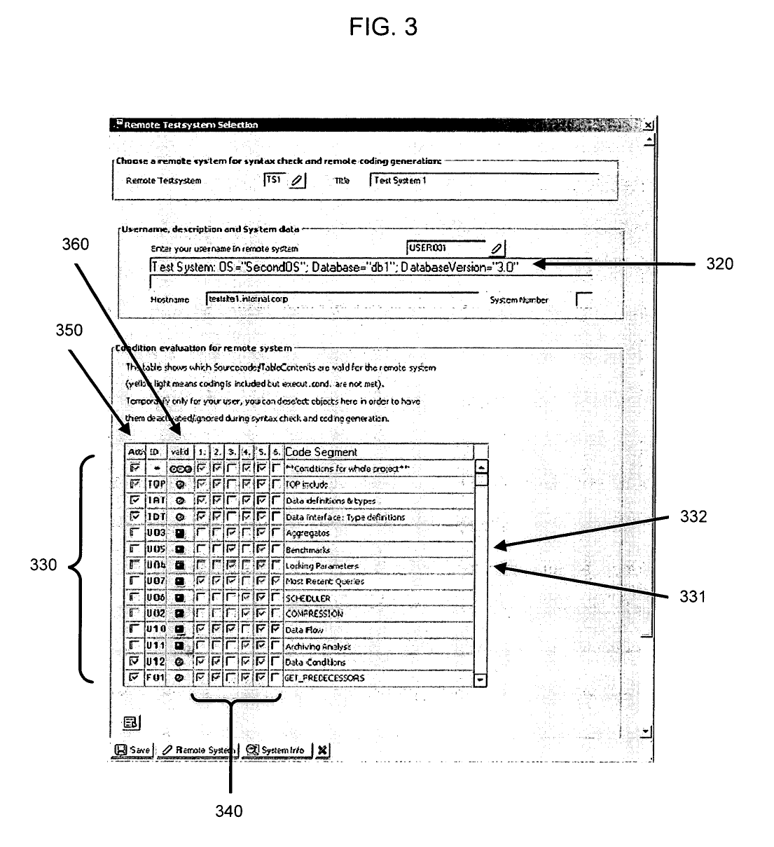

In addition to simplifying development and maintenance of software, the present invention may aid in testing the software or portions of the software as well. Since a system according to the present invention may include compatibility information for each source code segment in the system, it may be used to automate the generation of software versions for testing. FIG. 3 shows a non-limiting example screenshot of a system being used to assemble a version of a program for testing on a target system. Test System 1 (310) may be a test platform simulating a target operating system, database, installed components, and other environmental and system options. The example in FIG. 3 shows a screenshot of an interface set up to test software on a test platform 310. The example test platform is designed to test a version of the software designed for the operating system “SecondOS” and version “3.0” of database “db1” (320). The list in the bottom half of the window shows example source code segments 330 and a main indicator 360 that shows whether the source code segment is valid for the chosen target platform and whether it will be included in the current test. In some embodiments, a developer may select source code segments to be included for testing or remove source code segments that have been automatically selected, for example by toggling an indicator in the “Active” column 350. For example, a developer may specify a test for a specific version of the software. The system may then select all source code segments that have logical descriptors indicating the source code segments are designed for that version. Similarly, the system may select all source code segments designed for or compatible with a specific target platform for which a developer has initiated a test. Tests performed with testing systems according to the invention may be syntax checks, assembly and transfer of source code segments to executable programs on a test platform, runtime checks, or any other tests performed on software.

The system indicates in the “valid” column 360 that the source code segments group is valid and that the first three and last two source code segments are valid—that is, they have associated logical descriptors matching the attributes of the target platform—by displaying a circular indicator next to each valid source code segment in the list. In the specific example shown, each source code segment has logical descriptors matching an operating system of “SecondOS” and version “3.0” of database “db1.” Source code segments not designed for or compatible with the version being tested are marked as invalid. For example, the source code segment labeled “Locking Parameters” 331 may be designed only for use on a target platform having an operating system other than SecondOS, and is therefore not valid for the test being performed. Similarly, the source code segment labeled “Benchmarks” 332 may be invalid because it is designed for use with “SecondOS,” but not with database “db1.”

Other information associated with source code segments may be displayed. For example, option indicators 340 may provide information such as whether a source code segment is provided as comments in a patch or other portion of software, or whether the source code segment matches other conditions. The option indicators may thus inform a developer that a source code segment will be included in assembled software, but will only be executed on the target system if logical conditions associated with the source code segment are satisfied. Any other information may also be displayed.

The screenshot in FIG. 3 provides a non-limiting example of the type of operations systems according to the invention may perform or allow a developer to perform during a test of the system being designed. If logical descriptors are stored in the system for a significant portion of source code segments in the system, many of the operations described may be automated. For example, a developer may direct a testing system or an analysis system as previously described to prepare a test of the software on a specific platform. Source code segments may then be analyzed as described with reference to FIG. 1 to select the source code segments that are valid with respect to the test requested. Since logical descriptors can prevent a source code segment from being distributed to an invalid test system, tests may be performed for many or all available test systems simultaneously. In some embodiments, no manual control or input is required after a developer assigns logical descriptors during development of the source code segments. Such a process may reduce the time required to run a test or set of tests. This may allow for more automated and less error-prone testing than is otherwise possible.

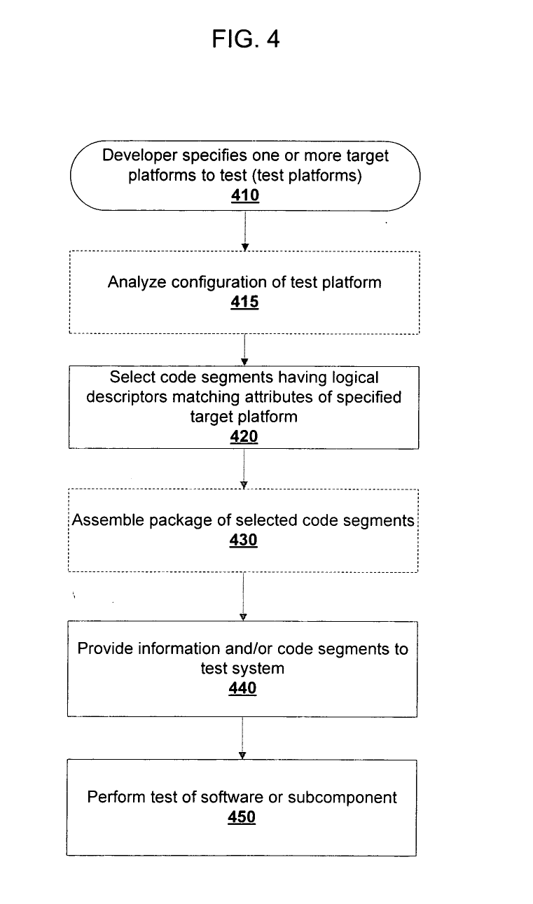

FIG. 4 shows an example process for testing software according to embodiments of the invention. A developer may choose one or more target platforms 410 for testing. The attributes describing the software configuration of each test platform may be collected by a target platform analysis system 415. Source code segments having logical descriptors matching attributes of the target platform may then be selected 420. The source code segments may be selected by the developer, a testing system, or an analysis system as previously described. If selected by a testing system or an analysis system, the matching source code segments may then be assembled or selected and provided to a testing system 430. An analysis system may also provide information to the developer or a testing system 440. Once source code segments having logical descriptors matching the target platform have been selected and assembled, a test of the software on the target platform may be performed 450. The test may be performed on a testing platform as previously described with respect to FIG. 1, or it may be performed in any other appropriate way.

Use of systems according to the invention may also allow for rapid and automated packaging of software for delivery to customers. As explained with respect to the packaging system 150 in FIG. 1, some embodiments of the invention allow for automated assembly of a specific patch for each customer's target platform. The packaging and delivery may be further automated if a customer's target platform may be analyzed by a target platform analysis system. For example, if software delivery is generally done via the Internet or other network delivery method, the target platform analysis may also be done via a network connection between the target platform analysis system and the target platform. Other delivery options may include assembly of a single patch for all target platforms, or a set of patches with each patch designed for a distinct set of target platforms. In some embodiments, delivery processes may be fully automated.

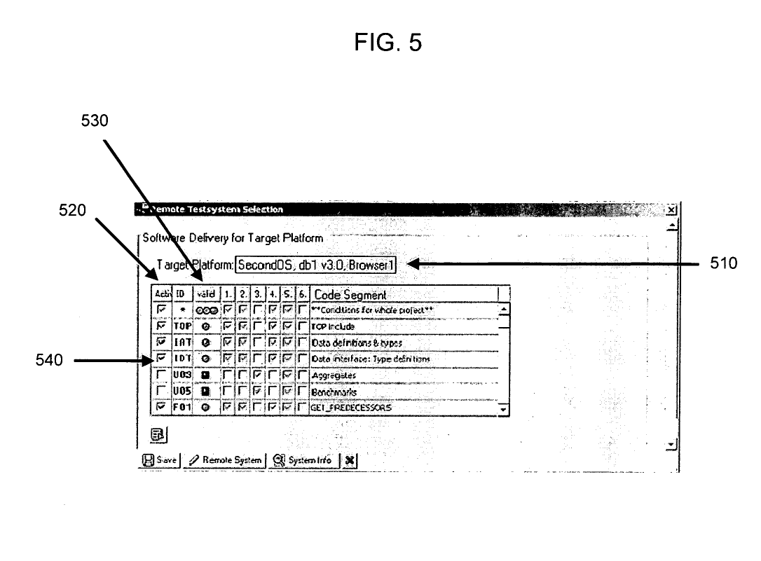

FIG. 5 shows a non-limiting example interface for packaging software for delivery. Similar to the process described with respect to FIG. 3, the system may analyze logical descriptors and select source code segments to be included in a specific configuration of the software. In the example shown in FIG. 5, a target customer platform includes the SecondOS operating system, version 3.0 of the db1 database, and additional software “Browser1” (510). The packaging system may compare logical descriptors associated with source code segments to attributes of the target platform, and select source code segments having matching descriptors. A logical descriptor analysis system may also be used as previously described. In some embodiments, a developer may select or deselect source code segments for inclusion via the Active column 520. If a source code segment is valid—that is, the logical descriptors associated with the source code segment indicate that the segment is compatible with the target platform—the packaging system may indicate that the segment can be included in the final package, for example as shown in the “valid” column 530. In the example interface shown in FIG. 5, all source code segments that have been selected for inclusion are valid. Two source code segments not selected, “Aggregates” and “Benchmarks” (540), are marked as invalid, as shown by the square indicators in the “valid” column 530. As described previously with respect to a testing system, the packaging or analysis system may select only source code segments designed for the target platform specified in the packaging system. Such integration may simplify delivery of the software to users, since it may allow for more automated delivery procedures.

After source code segments have been selected for inclusion in a software package or patch, an analysis system may provide information and/or source code segments to a packaging system. For example, if the source code segments are stored in a code repository such as a database, the analysis system may provide a list of source code segments to the packaging system. The packaging system may then select the appropriate source code segments to include in the program. The packaging system may also include logical descriptors in the package constructed for delivery to a customer. The software may then later make use of the logical descriptors, for example by self-modifying source code segments based on the descriptors. This may allow the software to be more responsive to changes in the target platform. As an example, the software may be configured to be compatible with several databases in the form in which it is delivered to the end user. When the software runs on the user's target platform, the software may analyze the target platform to determine which specific database or databases are installed. Using the stored logical descriptors, it may then modify the code installed on the target platform in order to use a specific database. Similarly, the logical descriptors may be used when the software is executed to determine whether a certain source code segment may be executed by the software.

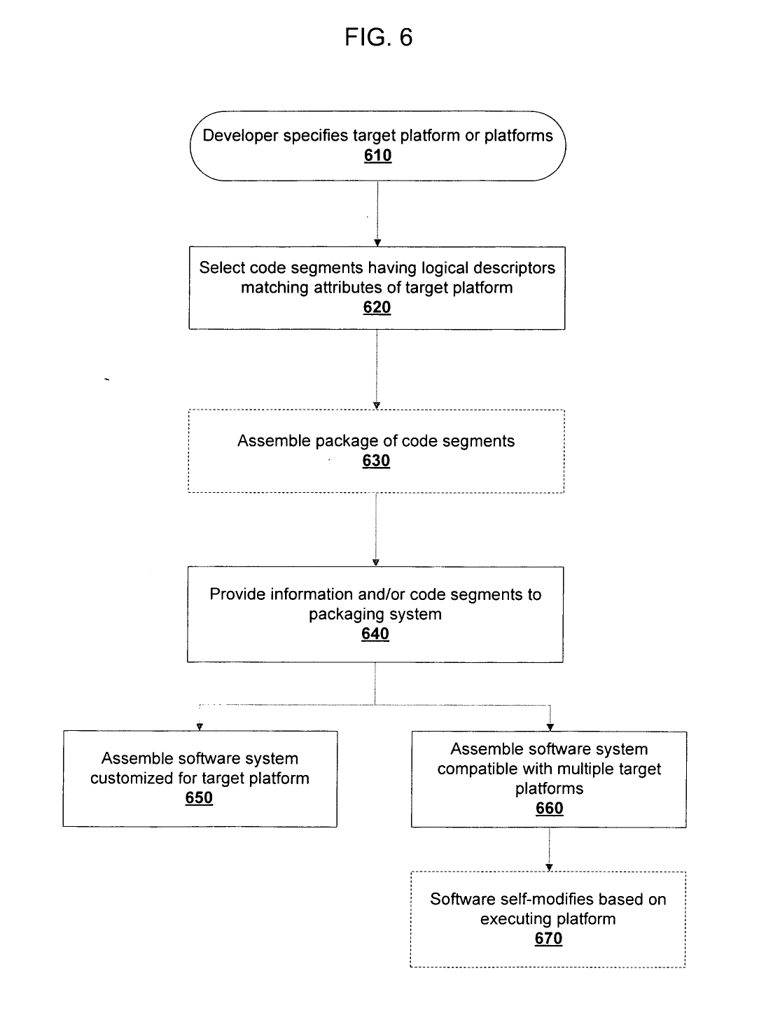

An example process of a packaging system used according to the invention is shown in FIG. 6. As described above, a target platform or platforms may be specified for which software is to be packaged 610. A developer may also specify the creation of software that is valid for some or all target platforms. Source code segments may then be selected that are compatible with the specified platform or platforms 620. This selection may be made by a packaging system or other analysis system as previously described. If an analysis system is used, it may assemble those source code segments having logical descriptors indicating the segments are compatible with the target platform 630. Information about those source code segments and/or the set of source code segments may then be provided to a packaging system 640. The packaging system may then assemble a program or patch for delivery to a customer. The program or patch may be customized for the user's target platform 650, or it may be compatible with multiple target platforms 660. If the program or patch is designed for use on multiple target platforms, it may contain self-modifying code that allows the software to adjust to different target platforms 670 based on the logical descriptors associated with source code segments incorporated into the software. Such modifications may be made, for example, to make use of different features or functionality present in different target platforms as previously described.

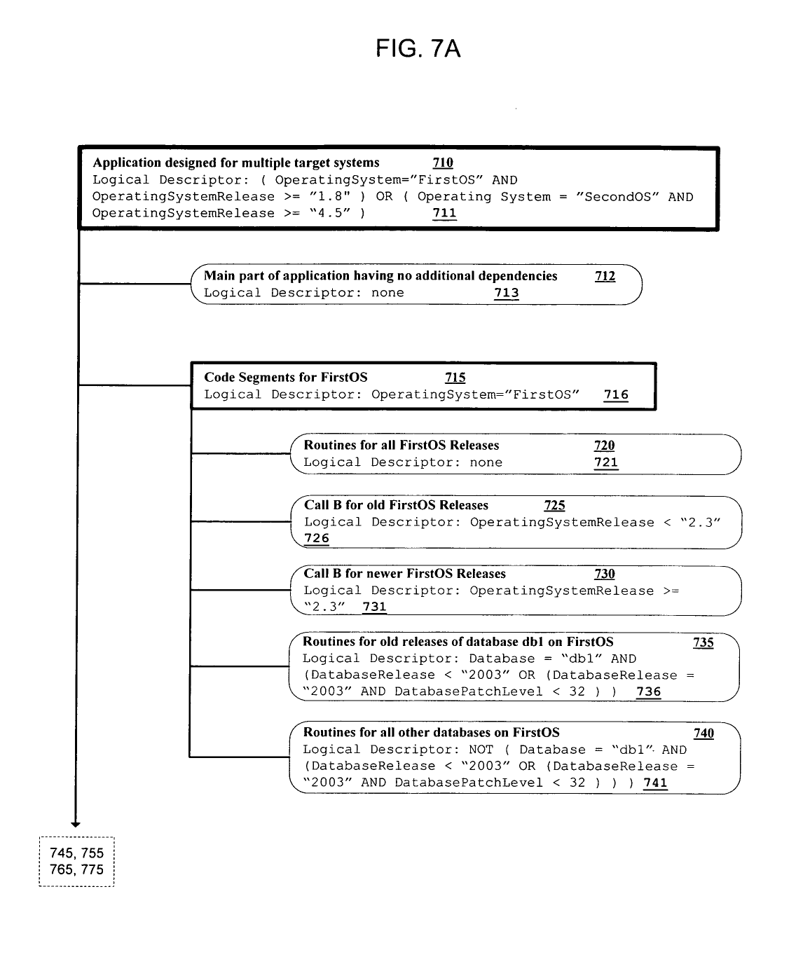

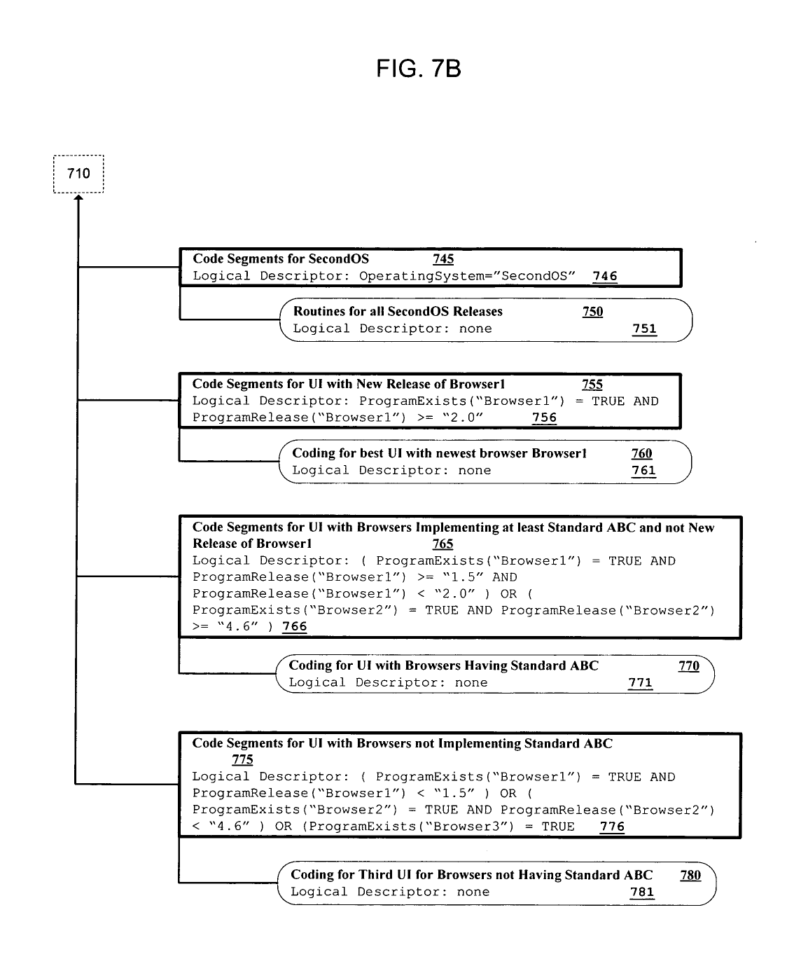

Source code segments associated with logical descriptors according to the invention may be displayed and arranged in various hierarchical structures. Logical descriptors describing attributes of the allowed target platforms may be attached to every hierarchy level of such a structure. A source code segment is valid if logical descriptors associated with the source code segment and all logical descriptors of hierarchy levels above the source code segment are fulfilled. FIGS. 7A-B show a non-limiting example of source code segments arranged in a hierarchy. Referring to FIG. 7A, the top node 710 shows that the application of the example is designed for certain releases of operating systems FirstOS and Second OS, as shown by an associated logical descriptor 711. The next hierarchy level source code segment contains the main part of the application that does not have additional conditions 712. Two subtrees 715 and 745 contain specialized source code segments designed for each of the operating systems FirstOS 715 and SecondOS 745. Below the hierarchy node 715, source code segment 720 may not include any further logical descriptors 721. Other code source code segments 725, 730 may contain mutually exclusive logical descriptors that further restrict the source code segments to certain releases of operating system FirstOS. For example, a source code segment 725 is only valid if all logical descriptors 711, 716 and 726 are fulfilled. In the example the source code segment 725 is effectively valid only on FirstOS for releases between 1.8 and 2.3. Similarly, other source code segments 735 and 740 may have mutually exclusive logical descriptors 736, 741 relating to other software installed on a target system. As a specific example, a source code segment 735 may be a workaround for a bug that existed on database db1 on operating system FirstOS, and that was solved with db1 release 2004 or with db1 release 2003 as of patch level 32. As shown by the associated logical descriptors 736, 741, if the database is db1 and the bug exists, source code segment 735 would be valid, otherwise source code segment 740 would be used.

Referring to FIG. 7B, a hierarchy node 745 may contain one or more source code segments 750 for use with a target platform having the SecondOS operating system. Other nodes on the first hierarchy level 755, 765 and 775, may again have mutually exclusive logical descriptors 756, 766, 776, respectively. The nodes may contain source code segments 760, 770, 780 defining a different user interface (UI) for the application based on compatibility of various web browsers or browser versions installed on the target platform. One node 755 may contain source code segments 756 defining a UI variant that requires at least version 2.0 of browser Browser1, as shown by the logical descriptor 756 associated with the node 755. Source code segments below the node 755 may have additional logical conditions associated with them, or they may have no further restrictions 761. A second UI variant that may, for example, be less visually appealing, may be supported on older browsers but require that the browser at least supports the standard ABC. A node 765 may be associated with a logical descriptor 766 defining this requirement. One or more source code segments 770 designed for such a system may be grouped under the node as shown. As previously described, such source code segments may have further logical descriptors 771. In the example and as shown by the logical descriptor 766, medium-old releases of browser Browser1 or releases of browser Browser2 of at least version 4.6 meet this requirement. Another UI, for example one that is the least user-friendly but is compatible with older browsers, may be defined as valid for all other older releases of browser Browser1 or Browser2, or for Browser3. As previously described, such a UI may be associated with a node 775 having a logical condition 776 defining the requirement. One or more source code segments 780 having additional logical descriptors 781 may be stored below the node 775. It will be understood that other logical descriptors may be constructed, using various combinations of attributes and values relevant to various target platforms. The hierarchies, source code segments, and logical descriptors described with respect to FIG. 7A-B are non-limiting examples. Other arrangements and organizations are possible.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for delivering software to a target platform, comprising:
comparing logical descriptors associated with source code segments to a set of attributes describing the target platform;
selecting at least one source code segment associated with logical conditions matching the set of attributes describing the target platform; and
compiling the at least one source code segment into a software program compatible with the target platform.

2. The method of claim 1 wherein the set of attributes describing the target platform is provided by the target platform or a computer program executed by the target platform.

3. The method of claim 1 wherein the set of attributes describing the target platform is provided by a developer.

4. The method of claim 1 wherein the set of attributes describing the target platform is provided by a target platform analysis system.

5. A method for testing software comprising, for a test platform:
comparing logical descriptors associated with source code segments to a set of attributes describing the test platform; and
selecting at least one source code segment having at least one logical descriptor specifying an attribute of the test platform; and
syntax-checking or compiling and executing the at least one source code segment on a test platform, the test platform having at least one attribute in common with the target platform.

6. The method of claim 5 wherein the test platform has the same attributes as the target platform.

7. A method for managing source code segments, comprising:
in response to a user specification of a target platform, selecting source code segments associated with logical descriptors;
comparing the logical descriptors associated with each source code segment to attributes of the target platform;
if the logical descriptors identify an attribute of the target platform, providing the source code segment associated with the logical descriptors.

8. The method of claim 7 wherein the source code segment is provided to a developer.

9. The method of claim 7 wherein the source code segment is provided to a testing system.

10. The method of claim 7 wherein the source code segment is provided to a packaging system.

11. The method of claim 7 wherein the source code segment is provided to a target platform.

12. A method for developing software for a target platform, comprising:
constructing a logical descriptor for a source code segment, the logical descriptor based on a set of attributes describing the target platform; and
assigning values to the one logical descriptor identifying attributes of the target platform for which the source code segment is valid.

13. The method of claim 12 wherein the set of attributes describing the target platform is provided by the target platform or a computer program executed by the target platform.

14. The method of claim 12 wherein the set of attributes describing the target platform is provided by a developer.

15. The method of claim 12 wherein the set of attributes describing the target platform is provided by a target platform analysis system.

16. The method of claim 12 wherein the logical descriptor defines a value for more than one of the attributes describing the target platform.

17. The method of claim 12 wherein the logical descriptor uses logical operators, Boolean operators, or both to define attributes of the target platform for which the source code segment is valid.

18. The method of claim 12 further comprising:
placing the source code segment into a hierarchy of source code segments, wherein each level of the hierarchy is defined by at least one logical condition associated with code segments, and each sub-level of the hierarchy is defined by additional logical conditions are associated with code segments and place further constraints on the source code segments contained in the sub-level.

19. A system comprising:
an integrated development environment; and
a source code segment repository comprising source code segments having logical descriptors, the logical descriptors specifying target platforms for which the source code segments are valid;
wherein the integrated development environment provides information describing valid target platforms for one or more source code segments.

20. The system of claim 19 further comprising a logical descriptor analysis system, wherein the logical descriptor analysis system provides information describing a valid target platform for one or more source code segments to the integrated development environment.

21. The system of claim 20 further comprising a testing system, wherein the logical descriptor analysis system provides information describing a valid target platform, source code segments, or both to the testing system.

22. The system of claim 20 further comprising a packaging system, wherein the logical descriptor analysis system provides information describing a valid target platform, source code segments, or both to the packaging system.

23. The system of claim 19 further comprising a target platform analysis system, wherein the target platform analysis system provides attributes describing a target platform.

24. A system comprising:
a code repository to store source code segments, at least one of the source code segments having at least one logical descriptor identifying attributes of a target system for which the source code segment is valid;
a logical descriptor analysis system to provide information about the at least one source code segment based on the at least one logical descriptor;
a testing system to construct tests of the at least one source code segment;
a packaging system to assemble the at least one source code segment for delivery to a customer; and
a target platform analysis system to provide attributes describing a target platform to be used to construct the at least one logical descriptor.

25. The system of claim 24 further comprising an integrated development environment to provide information about the at least one logical descriptor and the at least one source code segment.

26. The system of claim 25 wherein the logical descriptor analysis system provides information about the at least one source code segment to at least one of the testing system, the packaging system, or the integrated development environment.

27. A machine-readable medium containing program instructions for execution on a processor, which when executed cause the processor to perform:
gathering a set of attributes describing a target platform;
constructing at least one logical descriptor for at least one source code segment, the logical descriptor based on the set of attributes associated with the target platform; and
assigning values to the at least one logical descriptor identifying attributes of the target system for which the at least one source code segment is valid.

28. A machine-readable medium containing program instructions for execution on a processor, which when executed cause the processor to perform:
in response to a user specification of a target platform, selecting at least one source code segment having one or more logical descriptors;
comparing the one or more logical descriptors of the at least one source code segment to attributes of the target platform;
if the one or more logical descriptors identifies an attribute of the target platform, providing the source code segment associated with the one or more logical descriptors.

29. The machine-readable medium of claim 28, the processor further to perform compiling the source code segment into a software program compatible with the target platform.

30. The machine-readable medium of claim 28, the processor further to perform syntax-checking the source code segment.

31. The machine-readable medium of claim 28 wherein the source code segment is provided to a testing system.

32. The machine-readable medium of claim 28 wherein the source code segment is provided to a packaging system.
